(19) United States
(12) Patent Application Publication
(10) Pub. No.: US 2014/0353886 A1
(43) Pub. Date: Dec. 4, 2014

(54) Purification, Recovery, and Recycle of Vent Gas

(71) Applicant: AIR PRODUCTS AND CHEMICALS, INC., Allentown, PA (US)

(72) Inventors: Matthew J. Thayer, Breinigsville, PA (US); Jianguo Xu, Wrightstown, PA (US)

(73) Assignee: AIR PRODUCTS AND CHEMICALS, INC., Allentown, PA (US)

(21) Appl. No.: 14/285,717

(22) Filed: May 23, 2014

Related U.S. Application Data
(60) Provisional application No. 61/828,461, filed on May 29, 2013.

(51) Int. Cl. F27D 17/00

(52) U.S. Cl. CPC F27D 17/002; F27D 17/008
USPC 266/44; 266/144

(57) ABSTRACT

An apparatus and/or system and method for recycling vent gas from an autoclave is disclosed including cooling and cleaning a vent gas, introducing the cooled and cleaned resultant stream into a purification unit to remove at least a portion of the carbon dioxide and water vapor contained therein, and recycling the purified stream enriched in oxygen into the autoclave or another process requiring enriched oxygen.

### BACKGROUND

In non-ferrous metals processing, such as processing refractory ore to extract gold, autoclaves are often used to oxidize the ore (e.g., oxidize sulfide materials in the ore). As oxygen (O₂) in a feed gas is consumed in the autoclave, the purity of oxygen eventually becomes too low for the process to be effective, and the gases within the autoclave are vented.

In some instances, the vent gas from the autoclave may be vented to atmosphere. However, in addition to environmental concerns, such a practice may be regarded as wasteful, as the vent gas from the autoclave typically contains a significant amount of oxygen-containing gas and potentially useful energy (e.g., from heat and pressure). For example, the vent gas from the autoclave may be at approximately 40 bar and may contain close to 50% oxygen (vol), with the main impurities being water vapor (H₂O), carbon dioxide (CO₂), nitrogen (N₂), argon (Ar), sulfur oxides (SOₓ), and particulates.

Some prior art systems aim to utilize vent gas from autoclaves, but these systems fail to take advantage of the full utility of the vent gas stream. For example, one prior art system discloses a process of feeding vent gas from an autoclave directly back to the autoclave. Another prior art system discloses removing carbon dioxide from the vent gas of an autoclave and then recycling the vent gas back to the autoclave. However, both of these systems afford little or no flexibility in how the vent gas stream is processed and used, and, as a result, fail to maximize the value of the vent gas stream.

Accordingly, there is a need in the art for a cost-effective and flexible apparatus and process for processing autoclave vent gas for reuse in an autoclave and/or one or more additional processes of a metals processing plant.

### SUMMARY

Aspect 1: A method comprising: (a) withdrawing a first vent gas stream from an autoclave, the autoclave being operationally configured to oxidize ore and being part of an ore processing plant; (b) cooling the first vent gas stream; (c) removing sulfur oxides and particulates from the first vent gas stream using a vent gas scrubbing subsystem, thereby producing a second vent gas stream having a lower concentration of sulfur oxides than the first vent stream; (d) removing water vapor and carbon dioxide from the second vent gas stream using a carbon dioxide and water separation subsystem, thereby producing a third vent gas stream having a lower concentration of water vapor and carbon dioxide than the second vent gas stream; and (e) introducing the third vent gas stream into at least one process in the metals processing plant.

Aspect 2: A plant for processing non-ferrous ore comprising: an autoclave fluidly connected to a supply of an oxygen-rich feed gas and a supply of an aqueous ore slurry; a first vent gas conduit fluidly connected to the autoclave for venting a first vent gas stream from the autoclave, the first vent stream having a lower concentration of oxygen than the oxygen-rich feed gas; a scrubber subsystem fluidly connected to the first vent gas conduit, the scrubber subsystem operationally configured to remove sulfur dioxides from the first vent gas stream and produce a second vent gas stream through a second vent gas conduit, the second vent gas stream having a lower concentration of sulfur dioxides than the first vent gas stream; a first separation subsystem that that is operationally configured to remove carbon dioxide and water from the second vent gas stream and produce a third vent gas stream through a third conduit, the third vent gas stream having a lower carbon dioxide content and lower concentration of carbon dioxide and water than the second vent gas stream; wherein the third vent gas conduit that is fluidly connected to at least one selected from the group of: an expander used to generate power, a second separation subsystem, and a third subsystem that requires enriched oxygen.

### BRIEF DESCRIPTION OF THE DRAWINGS

The present invention will hereinafter be described in conjunction with the appended drawing figures wherein like numerals denote like elements:

FIG. 1 is a block diagram illustrating an autoclave vent gas system in accordance with an embodiment of the present invention;

FIG. 2 is a block diagram illustrating a carbon dioxide and water separation subsystem in accordance with an embodiment of the present invention;

FIG. 3 is a block diagram illustrating a carbon dioxide and water separation subsystem in conjunction with a nitrogen and argon separation subsystem in accordance with an embodiment of the present invention;

FIG. 4 is a block diagram illustrating a carbon dioxide and water separation subsystem in conjunction with a nitrogen and argon separation subsystem in accordance with another embodiment of the present invention;

FIG. 5 is a block diagram illustrating an autoclave in conjunction with a vent gas scrubbing subsystem in accordance with an embodiment of the present invention;

FIG. 6 is a block diagram illustrating an autoclave in conjunction with a heat exchanger and expander in accordance with an embodiment of the present invention; and

FIG. 7 is a flow diagram illustrating a method for processing vent gas from an autoclave in accordance with an embodiment of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. Various changes may be made in the function and arrangement of elements without departing from the spirit and scope of the invention, as set forth in the appended claims.

The term “conduit” or “line” as used in the specification and claims, refers to one or more structures through which fluids can be transported between two or more components of a system. For example, conduits can include pipes, ducts, and combinations thereof that transport liquids and/or gases at varying pressures throughout a production system.

The term “fluidly connected,” as used in the specification and claims, refers to the nature of connectivity between two or more components that enables liquids and/or gases to be transported between the components in a controlled fashion. For example, an outlet of a compressor can be fluidly connected to an inlet of a reactor such that a gas stream can be transported to the reactor without leakage. Coupling two or more components such that they are fluidly connected with each other can involve any suitable method known in the art, such as with the use of flanged conduits, gaskets, and bolts.

The term “concentration,” as used in the specification and claims, means molar percentage. For example, if a first gas stream is described as having a lower concentration of oxygen than a second gas stream, the first gas stream has a lower percentage of oxygen, on a molar basis, than the second gas stream.

In the claims, letters may be used to identify claimed method steps (e.g. a, b, and c). These letters are used to aid in referring to the method steps and are not intended to indicate the order in which claimed steps are performed, unless and only to the extent that such order is specifically recited in the claims.

In the Figures, conduits or lines are depicted as lines with arrows connecting one or more other components of the systems. Each such conduit or line is fluidly connected to an outlet of a component (i.e., the component from which the line originates) and an inlet of another component (i.e., the component at which the arrow terminates), such that a gas and/or liquid can be carried therebetween.

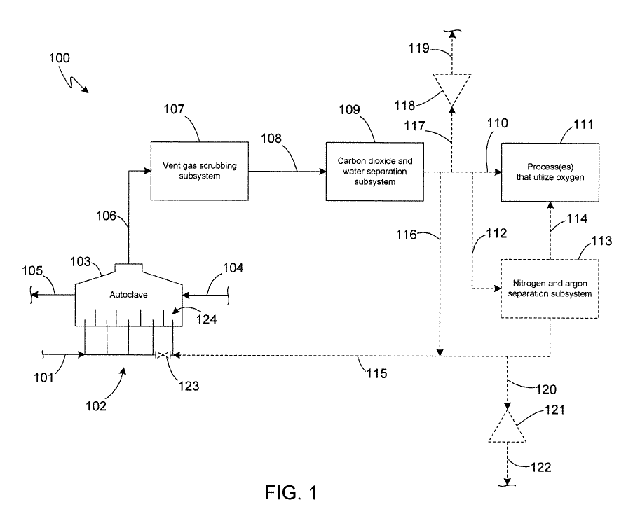

FIG. 1 is a block diagram illustrating an autoclave vent gas system 100 in accordance with an embodiment of the present invention. In this exemplary embodiment, the autoclave vent gas system 100 is used in a non-ferrous refractory ore processing plant. In other embodiments, the system 100 could be implemented in other types of metals processing plants. Oxygen gas (e.g., from an air separation unit) in conduit 101 is fed to an autoclave 103 through a sparger manifold 102. Ore is fed to the autoclave via conduit 104 (e.g., as an aqueous ore slurry containing pulverized ore). The sparger manifold 102 sparges the oxygen gas through ore contained in cells of the autoclave 103 in order to oxidize the ore. Ore within the autoclave 103 may be processed at high pressure and temperature (e.g., 22 bar and about 230° C.). Some of the oxygen is consumed in the autoclave 10, while impurities in the feed streams or formed from the reactions in the autoclave such as carbon dioxide, nitrogen, argon, and water vapor accumulate over time in the gas phase to cause the concentration of oxygen to diminish so that some gas has to be vented in order to maintain oxygen purity in the autoclave. This vent gas is withdrawn from the autoclave 103 via conduit 106 and is fed to a vent gas scrubbing subsystem 107. Typical operational flow rates for vent gas from an autoclave 103 used for ore processing is in the range of 1000-2500 tons per day of vent gas.

The vent gas scrubbing subsystem 107 cools and cleans the vent gas from the autoclave 10. For example, the vent gas scrubbing subsystem 107 may clean the vent gas to remove sulfur oxides and particulates so that any gas that is ultimately vented to atmosphere satisfies any environmental regulations. For example, the vent gas scrubbing subsystem 107 could utilize a cascade scrubber, a cascade scrubber or a verturi scrubber to remove sulfur oxides. Any suitable technology could be used to cool the vent gas. As another example, the vent gas scrubbing subsystem 107 could employ the cooling and sulfur removal methods and apparatuses described in U.S. Pat. No. 8,702,842, which is hereby incorporated by reference as if fully set forth.

The resultant cooled and cleaned vent gas, which, in this exemplary embodiment, mainly consists of oxygen, carbon dioxide, nitrogen, argon, and some remaining water vapor, is then fed via conduit 108 to a carbon dioxide and water separation subsystem 109 for removal of carbon dioxide and water vapor. For example, the carbon dioxide and water separation subsystem 109 may be implemented with membrane units, a variety of adsorption separation technologies, such as temperature swing adsorption (TSA), pressure swing adsorption (PSA), thermal pressure swing adsorption (TPSA), or thermally-enhanced pressure swing adsorption (TEPSA) techniques, and/or absorption technologies, such as those which use chilled methanol and a mixture of the dimethyl ethers of polyethylene glycol (DMPEG) as absorbents. The carbon dioxide- and water vapor-depleted vent gas stream is carried from the carbon dioxide and water separation subsystem 109 via conduit 110, where it can be used and/or purified in various ways.

In this exemplary embodiment, carbon dioxide- and water vapor-depleted vent gas may optionally be carried directly to one or more processes 111 that utilize an oxygen-enriched gas stream. Carbon dioxide- and water vapor-depleted vent gas may also optionally be carried to nitrogen and argon separation subsystem 113 to produce a higher purity oxygen stream (e.g., 95-99.9% mol oxygen), which can then be carried via conduit 114 to processes 111 that can utilize the higher purity oxygen stream. For example, the nitrogen and argon separation subsystem 113 may be implemented with a cryogenic air separation unit (ASU) using distillation separation, or with an adsorption separation system that contains one or more adsorbents that selectively adsorb nitrogen and/or argon.

The higher purity oxygen produced by the nitrogen and argon separation subsystem 113 may also be carried via conduit 115 to sparger manifold 102 for recycling back into the autoclave 103. Where vent gas is recycled to the autoclave 103, a recycle loop is created. If the autoclave vent gas system 100 does not incorporate a mechanism for removing nitrogen and argon (e.g., it does not utilize the nitrogen and argon separation subsystem 113 and the carbon dioxide and water separation subsystem 109 is not otherwise selective for nitrogen and argon), argon and nitrogen will accumulate in the autoclave 103 as the vent gas is recycled and oxygen is consumed, hindering the autoclaving process and, ultimately, recovery of the desired metal from the ore. The argon and nitrogen concentrations will continue to increase until the rates of argon and nitrogen leaving the recycle loop of the autoclave vent gas system 100 are less than or equal to the rates of argon and nitrogen entering the autoclave 103. As an alternative to using the nitrogen and argon separation subsystem 113 or another separation technique selective for nitrogen and argon, argon and nitrogen levels may be reduced by bleeding a portion of the vent gas from the vent gas scrubbing subsystem 107 or from another point in the autoclave vent gas system 100. Such bleeding can also be accomplished via use of optional expanders, as discussed below.

Carbon dioxide- and water vapor-depleted vent gas may optionally be carried via conduit 116 directly to conduit 115 and sparger manifold 102 for recycling back into the autoclave 103. For example, a recycled oxygen stream may comprise approximately 10-15% mol nitrogen and/or argon if not processed via the nitrogen and argon separation subsystem 113. In such a case, and in other scenarios where a relatively low purity oxygen stream (e.g., 80-90% mol oxygen) is recycled to the autoclave 103, it is preferable to feed the recycled stream to the cell(s) or stage(s) nearest the ore feed of the autoclave 103. Stated differently, it is preferable to feed the recycled stream to the region of the autoclave 103 having the greatest amount of non-oxidized ore. For example, in the embodiment shown in FIG. 1, the autoclave 103 has multiple cells, where cell 124 is the first cell nearest the ore feed input from conduit 104 such that the freshly fed ore passes through cell 124 before passing through other cells. The freshly fed ore has a relatively fast reaction rate and, therefore, can still react rapidly even if the recycled stream has a lower oxygen concentration. In this embodiment, a valve 123 is used in the sparger manifold 102 to separate the passage of gas to the sparger of the first cell 124 from the remainder of the spargers. The flow of the recycled stream to the first cell 124 can thereby be controlled by opening and closing the valve 123 (e.g., close the valve to provide the stream to the first cell where it will react more vigorously with fresh ore; open the valve when not recycling the stream, such as at the startup of a plant).

In addition to recycling to the autoclave 103, the processes 111 that may utilize the carbon dioxide- and water vapor-depleted vent gas and/or the higher purity oxygen stream include, but are not limited to, neutralization processes for ore slurry from the autoclave 103 in preparation for cyanide leaching, and operation of heat exchangers, roasters, and furnaces, ozone generation.

In this exemplary embodiment, optional expanders 118 and 121 may be used to provide mechanical and/or electrical energy where the pressures of the carbon dioxide- and water vapor-depleted stream and/or the higher purity oxygen stream are sufficiently high (e.g., greater than 3 psig). The vent gas from the autoclave 103 in a non-ferrous metals processing plant is at high pressure, typically greater than 22 bar. After passing through the carbon dioxide and water separation subsystem 109, the carbon dioxide- and water vapor-depleted vent gas can still be at relatively high pressure. For example, where a PSA system is used in the carbon dioxide and water separation subsystem 109, the pressure of the carbon dioxide- and water vapor-depleted vent gas may be 30 bar or higher if the vent gas scrubbing subsystem 107 does not significantly downgrade the pressure of the vent gas. Thus, carbon dioxide- and water vapor-depleted vent gas can be optionally carried via conduit 117 to optional expander 118, where it is expanded to generate power. The expanded carbon dioxide- and water vapor-depleted vent gas is then carried by conduit 119, where it can be vented to atmosphere and/or provided to another component or process (including autoclave 103 and processes 111). Similarly, higher purity oxygen produced by nitrogen and argon separation subsystem 113 can be carried via conduit 120 to optional expander 121 to generate power. The expanded higher purity oxygen can then be carried by conduit 122 and vented to atmosphere and/or provided to another component or process (including autoclave 103 and process 111) that can use it at such a low pressure. In yet another embodiment, the vent gas carried by conduit 106 from the autoclave 103 can first be expanded in an expander and then sent to vent gas scrubbing subsystem 107. In such a case, components used in the vent gas scrubbing subsystem 107 and/or carbon dioxide and water separation subsystem 109 may need to be adapted accordingly (e.g., using a vacuum swing adsorption (VSA) unit that operates PSA beds at vacuum for bed cleaning/regeneration).

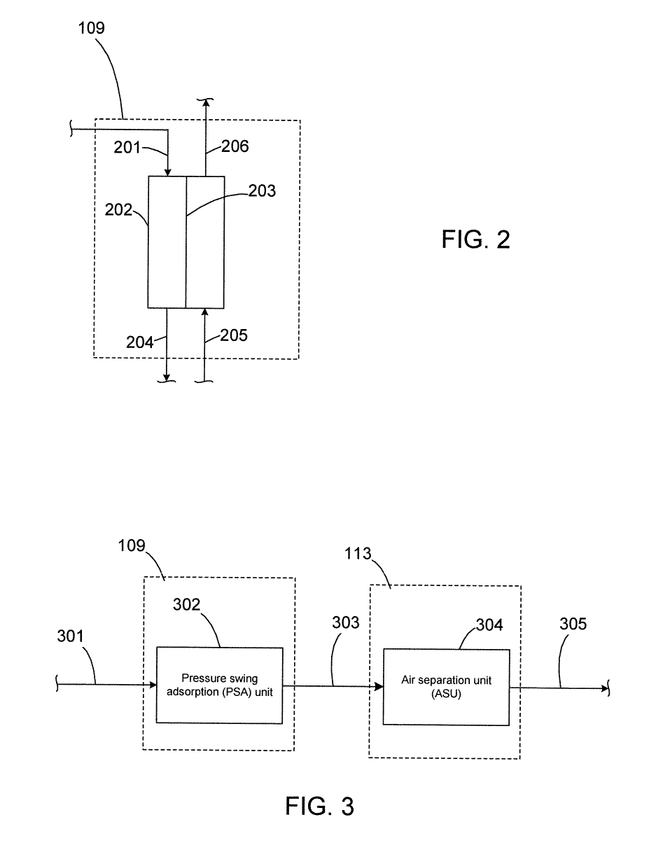

FIG. 2 is a block diagram illustrating a carbon dioxide and water separation subsystem 109 in accordance with an embodiment of the present invention. In this embodiment, the carbon dioxide and water separation subsystem 109 comprises a membrane unit 202. The membrane unit 202 comprises one or more membranes 203 that are selectively permeable to carbon dioxide and water vapor and divide one or more spaces within membrane unit 202 into a feed-retentate side and a permeate side. For example, the membrane unit 202 may be implemented with a hollow fiber polymeric membrane module having a plurality of hollow fiber polymeric membranes within a shell. In such a configuration, the feed-retentate side is the bore side of the plurality of hollow fiber polymeric membranes while the permeate side is the shell side. Cooled and cleaned vent gas from a vent gas scrubbing subsystem (e.g., vent gas scrubbing subsystem 107) is carried via conduit 201 to the feed-retentate side of the membrane unit 202. Carbon dioxide and water vapor permeate the one or more membranes 203 to the permeate side of the membrane unit 202 to create a permeate stream rich in carbon dioxide and water vapor, which is then carried from the membrane unit via conduit 206 and may be vented. Oxygen, argon, nitrogen, and some remaining water vapor and carbon dioxide that do not permeate the one or more membranes 203 and are retained in the retentate side of the membrane unit 202, creating a carbon dioxide and water vapor-depleted retentate stream that is withdrawn via conduit 204. An air sweep may be introduced into the permeate side of the membrane unit 202 via conduit 205, counter-current to the flow of the cooled and cleaned vent gas in the retentate side of the membrane unit 202. Using the air sweep promotes permeation of carbon dioxide and water vapor across the membrane 203 (and helps reduce carbon dioxide and water vapor levels in the retentate stream) by decreasing their partial pressures on the permeate side of the membrane unit 202.

Oxygen purity of the retentate stream in conduit 204 is preferably 80+% mol, making it suitable for a variety of applications in a metals processing plant, including recycling back to an autoclave (e.g., autoclave 103). If necessary, the retentate stream can also be further purified to increase its oxygen concentration.

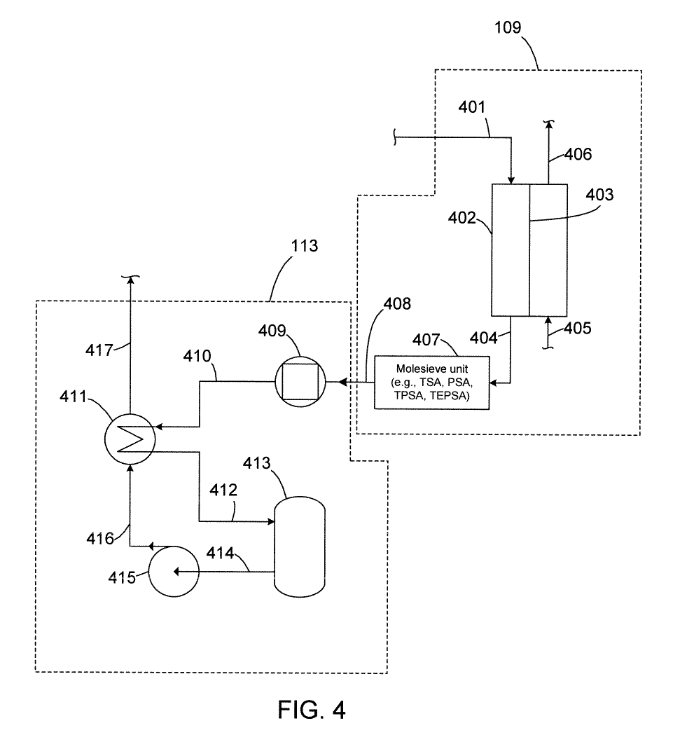

FIG. 3 is a block diagram illustrating a carbon dioxide and water separation subsystem 109 in conjunction with a nitrogen and argon separation subsystem 113 in accordance with an embodiment of the present invention. In this exemplary embodiment, the carbon dioxide and water separation subsystem 109 comprises a pressure swing adsorption (PSA) unit 302, and the nitrogen and argon separation subsystem 113 comprises a cryogenic air separation unit (ASU) 304.

Cooled and cleaned vent gas from a vent gas scrubbing subsystem (e.g., vent gas scrubbing subsystem 107) is carried via conduit 301 to the PSA unit 302 for removal of carbon dioxide and water vapor. If the cooled and cleaned vent gas is at a sufficiently high pressure (e.g., 100-600 psia), the PSA unit 302 may be implemented with a PSA unit similar to those used in H₂ pressure swing adsorption. Examples of PSA processes that may be used include, but are not limited, to those found in U.S. Pat. Nos. 6,425,938, 6,428,607, and 6,379,431, all of which are incorporated by reference herein. In one embodiment, a polybed PSA with four or more beds may be used to remove the carbon dioxide, water vapor, and nitrogen. In a typical polybed PSA process, there is at least a feed step during which product can also be made, a co-current depressurization—provide equalization step, a co-current depressurization—provide purge gas step, a counter-current blow down step, a counter-current purge step, a countercurrent receive pressure equalization step, and a (product and/or feed) repressurization step. The process may also contain an idle step in some instances. The adsorbent beds may contain two or more layers of adsorbents. For example, a layer of alumina or silica gel near the feed end of the beds can be used for carbon dioxide and water vapor removal, and a layer of nitrogen selective adsorbents such as 5A, LiX, or 13X near the product end of the beds can be used for nitrogen removal. For a higher recovery, a rinse step may be added after the feed step for each bed (i.e., the step in which the cooled and cleaned vent gas is fed to the bed) in order to recycle some of the off gas from the bed (e.g., off gas from the early part of a blowdown step) back to another bed that completed or has nearly completed the feed step. A compressor may be needed to bring the pressure of such recycled off gas back to a level that allows it to enter a bed at a similar pressure to the pressure of the feed gas. The rinse step may not be necessary if desired recovery does not have to be very high (e.g., 80% mol of the oxygen contained in the feed). If the cooled and cleaned vent gas contains a significant amount of argon, it may be possible that the optimal PSA cycle does not need a rinse step, although if necessary, an argon separation subsystem (e.g., nitrogen and argon separation subsystem 113) may be used to address the issue of argon accumulation in the product.

If the pressure of the cooled and cleaned vent gas is at a pressure close to atmospheric pressure (e.g., 0.1-10 psig), the PSA unit 302 may be implemented with a PSA system that works at vacuum for bed cleaning/regeneration (i.e., a VSA unit). Such a vacuum adsorption process may also be used to remove nitrogen and argon where the adsorbent bed(s) incorporate adsorbents selective for nitrogen and argon, such as lithium (Li) and silver (Ag) exchanged X-type zeolites. For example, the adsorbents may be arranged such that the adsorbents selective for water and carbon dioxide (e.g., alumina, silica gel, carbon, or NaX type zeolite) are near the entrance of the bed(s), followed by Li-exchanged X-type zeolite, and finally Ag-exchanged X-type zeolite (Such as AgLiLSX).

The resultant carbon dioxide- and water vapor-depleted vent gas stream is then carried from the PSA unit 302 via conduit 303 to the cryogenic air separation unit (ASU) 304 for removal of nitrogen and/or argon. The ASU 304 may be implemented with any suitable known ASU technology. The resultant higher purity oxygen stream (e.g., 95-99.9% mol oxygen) from the ASU 304 is carried via conduit 305, where it may be recycled back to an autoclave (e.g., autoclave 103) or be used in other components and processes in the metals processing plant.

FIG. 4 is a block diagram illustrating a carbon dioxide and water separation subsystem 109 in conjunction with a nitrogen and argon separation subsystem 113 in accordance with another embodiment of the present invention. The carbon dioxide and water separation subsystem 109 comprises a membrane unit 402 and molesieve unit 407. The membrane unit 402 possesses the same structure and functionality as the membrane unit 202 of FIG. 2 (with reference numerals having been increased by 200) and therefore will not be described again in detail.

In this exemplary embodiment, the retentate stream from the membrane unit 402 is carried via conduit 404 to the molesieve unit 407 to remove additional carbon dioxide and water to below ppm levels such that they will not freeze out and cause problems downstream in the cryogenic section of the ASU. The molesieve unit 407 may be implemented with any suitable known molecular sieve technology, such as, for example, one or more adsorbent beds that operate via known temperature swing adsorption (TSA), pressure swing adsorption (PSA), thermal pressure swing adsorption (TPSA), or thermally-enhanced pressure swing adsorption (TEPSA) techniques.

The nitrogen and argon separation subsystem 113 comprises an ASU (not separately shown) having a compressor 409, a heat exchanger 411, a low pressure (LP) column 413, and a liquid oxygen (LOX) pump 415. It will be understood that the ASU may include additional components and involve additional processes that have been omitted for illustrative purposes.

The carbon dioxide- and water vapor-depleted stream from the molesieve unit 407 is fed via conduit 408 to the compressor 409 to increase the pressure of the stream, after which the pressurized stream is carried via conduit 410 to the heat exchanger 411, where the stream is condensed against liquid oxygen (LOX, discussed below). The condensed carbon dioxide- and water vapor-depleted stream is carried via conduit 412 and fed to the LP column 413 (e.g., at a crude LOX feed location or in a location above where the feed to the argon column is drawn). Such a process may, however, increase the burden of the lower section of the LP column 413 and might reduce oxygen purity somewhat. If the original oxygen purity has to be maintained, more reboiling in the LP column bottom and condensing at a higher location may be needed, which can be provided, for example, by heat pumping.

LOX from the bottom of the LP column is pumped by LOX pump 415 through conduit 414 and conduit 416 to the heat exchanger 411. The purified gaseous oxygen stream (e.g., 99.7% mol oxygen) that results from vaporizing the LOX by heat exchange with the retentate stream is carried via conduit 417, where it may be recycled to an autoclave (e.g., autoclave 103) or used in another component and/or process in the metals processing plant.

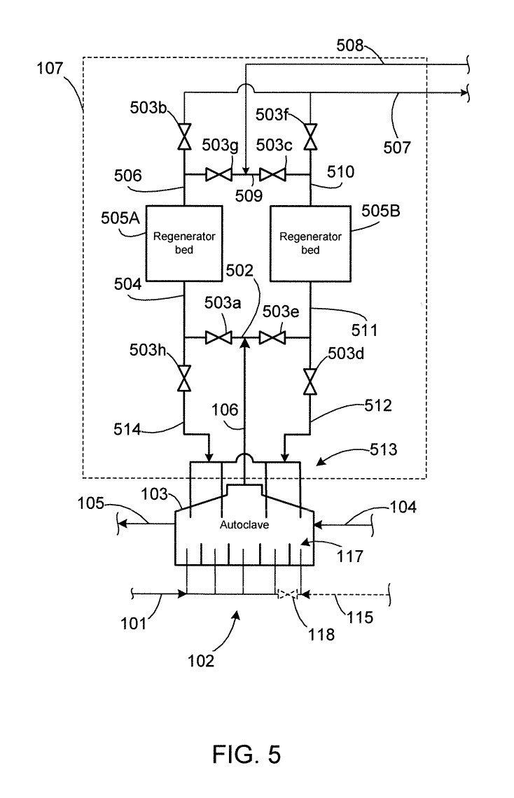

FIG. 5 is a block diagram illustrating the autoclave 103 in conjunction with a vent gas scrubbing subsystem 107 in accordance with an embodiment of the present invention. In this exemplary embodiment, the vent gas scrubbing subsystem 107 includes a reversible generator comprising regenerator beds 505a and 505b which remove SOx, water vapor, and particulates from the vent gas of the autoclave 103. The regenerator beds 505a and 505b may contain ceramic particles such as alumina balls whose surfaces act as contact areas for mass transfer, and whose heat capacity is used for heat storage. However, it is not necessary that the bed contain balls or other forms of particles. Monolithic ceramic materials with straighter passages can be used to reduce the tendency for the particulates to stay in the bed.

During a cycle, the vent gas from autoclave 103 is carried via conduit 106 to conduit 502. The vent gas then passes through valve 503a and conduit 504 to regenerator bed 505a, where it is cooled to a temperature that is close to the ambient temperature, preferably within 10 degrees C. above or below ambient temperature. As the vent gas is cooled, water vapor within it is condensed. The resultant liquid water flows downward and is accumulated in the bottom of regenerator bed 505a, picking up vapor of sulfuric acid and other components, as well as particulates entrained by the vent gas stream in the process. The cooled and cleaned vent gas is carried from regenerator bed 505a through conduit 506, valve 503b, and conduit 507, after which it can be further treated and purified (e.g., passed to carbon dioxide and water separation subsystem 109). On the other side, a makeup oxygen stream, which may contain 0.1-0.5% mol argon and typically is near ambient temperature, is carried through conduit 508, conduit 509, valve 503c, and conduit 510, and is fed to regenerator bed 505b, where it cools down regenerator bed 505b (which previously received and cooled the hot vent gas in a prior cycle) and blows down liquid and solid particulates entrained by the liquid so they can be collected at the bottom of regenerator bed 505b. The acidic solution and solid particulates from regenerator bed 505b can be sent back to the autoclave 103 through the sparger 513, or can be trapped for use elsewhere, such as in another component of the metals processing plant.

During another cycle, the vent gas from autoclave 103 is carried via conduit 106 and conduit 502, but passes through valve 503e and conduit 511 to regenerator bed 505b. As the vent gas is cooled, water vapor within it is condensed, and the resultant liquid water flows downward and is accumulated in the bottom of regenerator bed 505b, picking up vapor of sulfuric acid and other components, as well as particulates entrained by the vent gas stream in the process. The cooled and cleaned vent gas is carried from regenerator bed 505b through conduit 510, valve 503f, and conduit 507, after which it can be further treated and purified (e.g., passed to carbon dioxide and water separation subsystem 109). On the other side, the makeup oxygen stream is now carried through conduit 508, conduit 509, valve 503g, and conduit 506, and is fed to regenerator bed 505a, where it cools down regenerator bed 505a and blows down liquid and solid particulates entrained by the liquid so they can be collected at the bottom of regenerator bed 505a. Again, the acidic solution and solid particulates from regenerator bed 505a can be sent back to the autoclave 103 through the sparger 513, or can be trapped for use elsewhere, such as in another component of the metals processing plant.

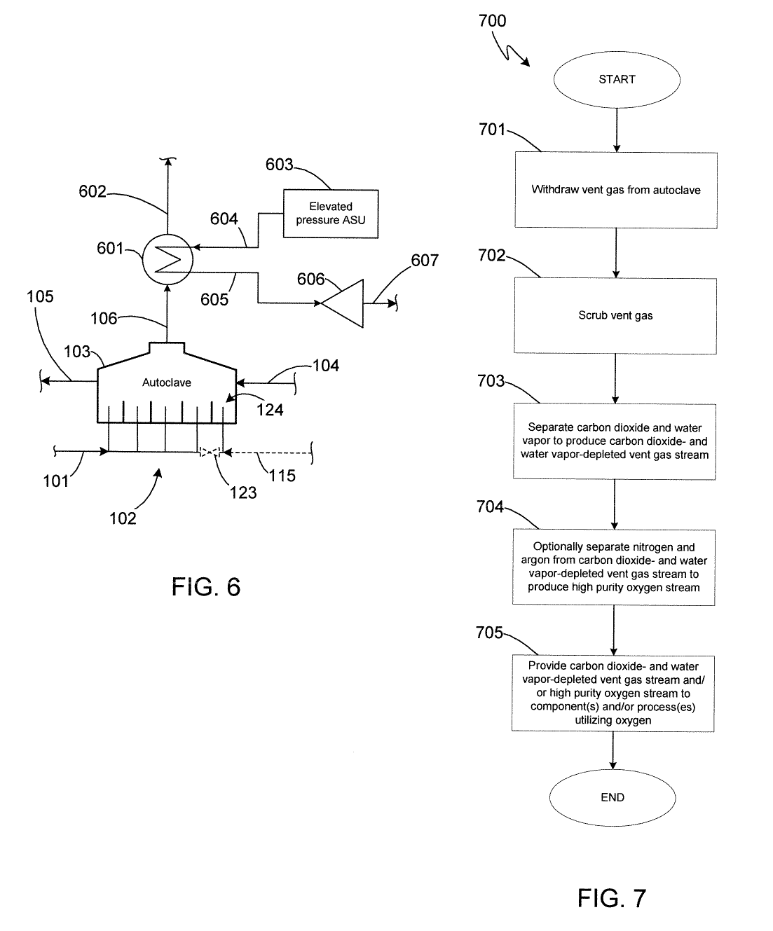

FIG. 6 is a block diagram illustrating the autoclave 103 in conjunction with a heat exchanger 601 and expander 606 in order to generate power using hot vent gas from the autoclave 103. Ore within the autoclave 103 may be processed at high pressure (e.g., 340 psia) and about 230° C. for the purposes of non-ferrous metals processing. The heat of the vent gas exiting the autoclave 103 via conduit 106 may be used to produce power. In other embodiments, the heat of the ore residue (i.e., pregnant liquor) exiting via conduit 105 may also be similarly used to produce power.

In this exemplary embodiment, the hot vent gas from the autoclave 103 is carried via conduit 106 to the heat exchanger 601, where it is cooled against elevated pressure nitrogen (e.g., 30-50 psia) carried via conduit 604 from an elevated pressure ASU 603. This nitrogen may or may not be further pressurized after it exits the elevated pressure ASU 603. Water (not shown) may be added to the nitrogen in conduit 604 before or as it enters the heat exchanger 601. The heated nitrogen stream is carried via conduit 605 to expander 606, where it is expanded to generate power. The expanded nitrogen stream is carried via conduit 607, where it may be vented to atmosphere or used in another component or process. The cooled vent gas is carried from the heat exchanger 601 via conduit 602, after which it can be treated and purified (e.g., passed to carbon dioxide and water separation subsystem 109). Use of an elevated pressure cycle may significantly reduce the size of equipment that is needed (e.g., the size of the heat exchanger 601, conduits 605 and 605, a front-end molesieve unit, and LP column), as well as reduce the pressure drop losses. The power generated by the expander 606 and the savings in the elevated pressure ASU 603 due to the use of higher feed pressure may more than compensate for the energy cost required to compress and expand the feed stream.

FIG. 7 is a flow diagram illustrating a method 700 for processing vent gas from an autoclave in accordance with an embodiment of the present invention. In step 701, a vent gas is withdrawn from an autoclave of a metal ore processing plant (e.g., autoclave 103).

In step 702, the vent gas is scrubbed (e.g., with a vent gas scrubbing subsystem 107) to cool the vent gas and remove water vapor and one or more impurities, such as sulfur oxides and particulates, and produce a cooled and cleaned vent gas stream. For example, the resultant cooled and cleaned vent gas may comprise oxygen, carbon dioxide, nitrogen, argon, and some remaining water vapor.

In step 703, carbon dioxide and additional water vapor is separated from the cooled and cleaned vent gas (e.g., with carbon dioxide and water separation subsystem 109) to produce a carbon dioxide- and water vapor-depleted vent gas stream (e.g., comprising 80-90% mol oxygen).

In step 704, nitrogen and argon are optionally separated from the carbon dioxide- and water vapor-depleted vent gas stream (e.g., with nitrogen and argon separation subsystem 113) to produce a higher purity oxygen stream (e.g., comprising 99.7% mol oxygen).

In step 705, the carbon dioxide- and water vapor-depleted vent gas stream and/or the higher purity oxygen stream are provided to one or more processes that can utilize the streams (e.g., provided to one or more processes 111 and/or recycled to autoclave 103).

### EXAMPLE 1

The following is an example of modeled specific operating parameters for system 100, using a pressure-swing adsorption unit as the carbon dioxide and water separation subsystem 109. Vent gas from the autoclave 103 is cooled and cleaned using the vent gas scrubbing subsystem 107. The vent gas scrubbing subsystem 107 produces a vent gas stream having a composition (percentages are on a molar basis) of 60% oxygen, 6% argon and nitrogen, and 35% carbon dioxide. The vent gas stream 107 that is at a pressure of 33 atm (3344 kPa), cooled to a temperature of 100 degrees F. (38 degrees C.), and is fed into a pressure swing adsorption (PSA) system. The PSA unit consists of ten (10) adsorbent beds, each containing silica gel. The adsorbent beds are operated so that two beds are always performing a feed step, and each bed goes through 4 steps of pressure equalization in a cycle. The product gas from the PSA system (referred to in the claims as the third vent gas) has the following composition (percentages are on a molar basis): 90% oxygen, 9% argon and nitrogen, and 1% carbon dioxide. In this example, over 92% of the oxygen in the feed can be recovered.

### EXAMPLE 2

The following is an example of modeled specific operating parameters for system 100, using a pressure-swing adsorption unit followed by a temperature swing adsorption unit as the carbon dioxide and water separation subsystem 109 and a cryogenic distillation column as the nitrogen and argon separation subsystem 113. As in the previous example, the vent gas from the autoclave 103 is first cooled and cleaned using the vent gas scrubbing subsystem 107.

In this example the oxygen-rich feed gas supplied to the autoclave is 99.5% or higher purity oxygen. The balance of the feed gas is argon and contains very little nitrogen. Accordingly, the gas removed by the nitrogen and argon separation subsystem 113 will consist essentially of argon. As noted above, removal of argon is important in order to avoid the accumulation of high levels argon that would occur if the vent gas from the PSA unit was recycled to the autoclave 103 without removing argon. In addition, argon may be beneficially used in other processes being performed on the site at which the system 100 is located.

Pressure of the vent gas leaving the PSA unit is increased to 46 atm (4663 kPa) and further purified in the temperature swing adsorption unit to remove the carbon dioxide and reduce carbon dioxide in the vent gas from the temperature swing adsorption unit to less than one part-per-million. The vent gas from the temperature swing adsorption unit is then cooled to below its boiling point and fed into the distillation column. At this point, the gas consists essentially of argon and oxygen. The distillation column separates the argon/oxygen mixture into a liquid oxygen product having 99.8% oxygen at the bottom of the column and an argon rich overhead vapor. The liquid oxygen from the bottom of the distillation column is then pumped to a pressure that is higher than the pressure of the autoclave (41 atm; 4157 kPa), heated, vaporized, and further heated via heat exchange with the vent gas from the temperature swing adsorption unit. Oxygen gas is then be recycled into the autoclave without the need for a compressor.

The overhead argon can be further purified and produced as an argon product, or heated and vented into atmosphere. Some of the argon-rich overhead gas is optionally heated, compressed, cooled, and then condensed in the reboiler of the distillation column, and then sent to the top of the column to serve as the reflux to the column.

Based on modeling of this example, recovery of up to 99.9% of the oxygen from the autoclave vent gas is possible, especially if the system 100 is configured for maximum argon recovery.

Optionally, nitrogen rich gas from the cryogenic air separation unit used to supply oxygen-rich gas to the autoclave 103 can be used to regenerate the beds of the TSA unit. In addition, argon-rich gas from the cryogenic distillation column could optionally be used to purge nitrogen from the TSA beds.

Optionally, the vent gas from the TSA unit could be fed to the low pressure column of the ASU at a position that is at or near where a vapor stream is removed from the low pressure column and send to the argon column, and the bottoms liquid of the argon column is sent to the low pressure column.

While the principles of the invention have been described above in connection with preferred embodiments, it is to be clearly understood that this description is made only by way of example and not as a limitation of the scope of the invention.

1. A method comprising:
(a) withdrawing a first vent gas stream from an autoclave, the autoclave being operationally configured to oxidize ore and being part of an ore processing plant;
(b) cooling the first vent gas stream;
(c) removing sulfur oxides and particulates from the first vent gas stream using a vent gas scrubbing subsystem, thereby producing a second vent gas stream having a lower concentration of sulfur oxides than the first vent stream;
(d) removing water vapor and carbon dioxide from the second vent gas stream using a carbon dioxide and water separation subsystem, thereby producing a third vent gas stream having a lower concentration of water vapor and carbon dioxide than the second vent gas stream; and
(e) introducing the third vent gas stream into at least one process in the metals processing plant.

2. The method of claim 1, wherein step (d) comprises introducing at least a first portion of the third vent gas stream into the autoclave and the method further comprises:
(f) removing nitrogen and/or argon from the third vent gas stream prior to performing step (e).

3. The method of claim 2, wherein the autoclave includes a plurality of cells and an inlet conduit through which ore is introduced into the autoclave, a first cell of the plurality of cells being located closest to the inlet conduit, and wherein step (e) comprises introducing the third vent gas stream into the first cell.

4. The method of claim 2, wherein the autoclave includes a plurality of cells and an inlet conduit through which ore is introduced into the autoclave, a first cell containing the largest amount of non-oxidized ore of the plurality of cells, and wherein step (e) comprises introducing the third vent gas stream into the first cell.

5. The method of claim 1, wherein step (e) comprises introducing at least a first portion of the third vent gas stream into at least one process selected from the group consisting of: a neutralization of ore slurry from the autoclave in preparation for cyanide leaching, a roasting process, and a heating process in a furnace.

6. The method of claim 1, further comprising:
(g) removing nitrogen and argon from the third vent gas stream by introducing the third vent gas stream into a nitrogen and/or argon separation subsystem, thereby producing a fourth vent gas stream having a higher oxygen concentration the third vent gas stream.

7. The method of claim 6, wherein step (g) removing nitrogen and/or argon from the third vent gas stream by introducing the third vent gas stream into a nitrogen and/or argon separation subsystem comprising a cryogenic air separation unit, thereby producing a fourth vent gas stream having a higher oxygen concentration the third vent gas stream.

8. The method of claim 6, further comprising:
(h) introducing at least a portion of the fourth vent gas stream into a component in the metals process plant that utilizes an oxygen-enriched gas stream.

9. The method of claim 7, wherein step (h) comprises introducing at least a portion of the fourth vent gas stream into the autoclave.

10. The method of claim 1, wherein step (c) comprises removing sulfur oxides and particulates from the first vent gas stream by introducing the first vent gas stream into a vent gas scrubbing subsystem comprising two or more reversible generator beds, thereby producing a second vent gas stream.

11. The method of claim 1, wherein step (e) further comprises removing water vapor and carbon dioxide from the second vent gas stream using a carbon dioxide and water separation subsystem comprising at least one membrane unit having at least one membrane that is more permeable to carbon dioxide and water vapor than to oxygen, thereby producing a third vent gas stream.

12. The method of claim 1, wherein step (e) further comprises removing water vapor and carbon dioxide from the second vent gas stream using a carbon dioxide and water separation subsystem comprising an adsorbent unit, thereby producing a third vent gas stream.

13. The method of claim 1, further comprising:
(i) generating power by expanding at least a portion of at least one stream selected from the group of: the first vent gas stream, the second vent gas stream, the third vent gas stream, and the fourth vent gas stream to generate power.

14. A plant for processing non-ferrous ore comprising:
an autoclave fluidly connected to a supply of an oxygen-rich feed gas and a supply of an aqueous ore slurry;
a first vent gas conduit fluidly connected to the autoclave for venting a first vent gas stream from the autoclave, the first vent stream having a lower concentration of oxygen than the oxygen-rich feed gas;
a scrubber subsystem fluidly connected to the first vent gas conduit, the scrubber subsystem operationally configured to remove sulfur dioxides from the first vent gas stream and produce a second vent gas stream through a second vent gas conduit, the second vent gas stream having a lower concentration of sulfur dioxides than the first vent gas stream;
a first separation subsystem that that is operationally configured to remove carbon dioxide and water from the second vent gas stream and produce a third vent gas stream through a third conduit, the third vent gas stream having a lower carbon dioxide content and lower concentration of carbon dioxide and water than the second vent gas stream;
wherein the third vent gas conduit that is fluidly connected to at least one selected from the group of: an expander used to generate power, a second separation subsystem, and a third subsystem that requires enriched oxygen.

15. The plant of claim 14, wherein the second separation subsystem is operationally configured to remove argon from the third vent gas stream to produce a fourth vent gas stream that exits the second separation subsystem through a fourth vent gas conduit.

16. The plant of claim 15, wherein the second separation subsystem is operationally configured to remove nitrogen from the third vent gas stream.

17. The plant of claim 15, wherein the fourth vent gas conduit is fluidly connected to the autoclave.

18. The plant of claim 16, wherein the autoclave further comprises a plurality of cells, the plurality of cells comprising a first cell which contains ore having a greater oxygen concentration that any other of the plurality of cells and wherein the fourth vent gas conduit is fluidly connected to a first cell.

19. The plant of claim 14, wherein the scrubber subsystem comprises at least two reversible regenerator beds.

20. The plant of claim 14, wherein the first separation subsystem comprises at least one membrane unit having at least one membrane that is more permeable to carbon dioxide and water vapor than to oxygen.
